(19) United States
(12) Patent Application Publication
(10) Pub. No.: US 2020/0257191 A1
(43) Pub. Date: Aug. 13, 2020

(54) Mercury Vapor Apparatus

(71) Applicant: Michael A. Robinson, Toronto (CA)

(72) Inventor: Michael A. Robinson, Toronto (CA)

(21) Appl. No.: 16/273,491

(22) Filed: Feb. 12, 2019

(51) Int. Cl. G03D 7/00; G03D 17/00

(52) U.S. Cl. CPC G03D 7/00; G03B 19/10; G03D 17/00

(57) ABSTRACT

The invention is an improved mercury vapor apparatus for developing daguerreotype photographs and modified daguerreotype methods for the production of holograms and etched semiconductor masks, or other types based on the daguerreotype process. The improved mercury vapor apparatus uses 99.99% less mercury by weight than the traditional inverted pyramid apparatus used by those skilled in the art. This is accomplished by replacing liquid mercury with a metal plate amalgamated with mercury to serve as the source for mercury vapor, providing improved convenience for chemical handling and safety. The mercury vapor apparatus is easily transported and eliminates any risks due to spilled mercury. Furthermore, the mercury vapor apparatus is adapted for developing daguerreotype plates, and other types based on the daguerreotype process, while in the camera plate holder, effectively blocking actinic light from spoiling the plate and eliminating the need for darkroom facilities.

### BACKGROUND

The daguerreotype photographic process, and modified daguerreotype methods for the production of holograms and etched semiconductor masks, requires mercury vapor to develop a polished silver surfaced plate that has been chemically photosensitized by a halogen or halogens.¹² The photosensitive surface is exposed to recording illumination in a camera plate holder or other means and the silver plate with its latent image is then developed over mercury vapor. To complete the photograph, a fixer removes the silver halide(s) to make the image lightfast and permanent. ¹Humphrey, Samuel D. American Hand-Book of the Daguerreotype . . . Containing the Daguerreotype, Electrotype And . . . Other Processes . . . Fifth Edition. New York, 1858. Print.² Teitel, Michael. Master Hologram and Micropattern Replication Method. U.S. Pat. No. 5,059,499. 1991.

The mercury apparatus currently in use by those skilled in the art is an inverted pyramid constructed of iron, painted steel, stainless steel or wood, of a size to suit the dimensions of the silver surfaced plate on which the image is formed. A volume of liquid mercury, for example 25 mL equivalent to 335 g, is poured into the apparatus directly, or into a metal cup, which in some embodiments is removable to assist in handling the liquid mercury, and fixed to the bottom of the pyramid while in use. The mercury is heated by an external flame or electric heater to 155° F.˜195° F. to increase the mercury vapor pressure within the apparatus, and the exposed daguerreotype plate is removed from the camera plate holder under non-actinic light (otherwise known as a darkroom or safelight conditions) and placed in suspension over the mercury vapor to develop a visible image.

The first difficulty with the current apparatus is that liquid mercury must be used with adequate ventilation such as a laboratory fume hood for operator safety. Secondly, the apparatus must be used in a suitable darkroom. This poses a challenge for artists wishing to make daguerreotypes (or other types based on daguerreotypes) in remote locations because the latent image often degrades after camera exposure due to time delays while returning to the laboratory. Success with the daguerreotype process is best achieved if the latent image can be developed with mercury vapor immediately after camera exposure. Thirdly, travel with a mercury apparatus to enable development on location is difficult because of the above noted ventilation and darkroom requirements, and that liquid mercury cannot be transported on commercial airlines. Therefore, what it is clearly needed is a mercury apparatus that solves the above limitations.

### BRIEF SUMMARY OF THE INVENTION

The inventor realized that replacing the liquid mercury with another substance of equal effectiveness would mitigate the limitations with the mercury vapor apparatus currently in use by those skilled in the art. This is accomplished in the present invention by substituting liquid mercury with a silver or other metal plate that has on its surface a solid solution of mercury or amalgam of mercury with the base metal. The amalgamated plate is indirectly heated to release mercury vapor sufficient to develop the daguerreotype, or other types based on mercury vapor development. Unlike liquid mercury, metal plates coated with silver-mercury amalgam are safely transported with no risk of spillage or contamination while in luggage.

In a preferred embodiment of the present invention, a sliding cover panel constructed of stainless steel or other material is provided to seal the mercury vapor within a shallow chamber to protect the surrounding atmosphere against mercury vapor contamination. In use, the sliding cover panel is drawn to allow mercury vapor to combine with the daguerreotype plate, or other types based on the daguerreotype process, having been placed in suitable frame immediately above the sliding cover. In an advantageous embodiment of the present invention, this frame is adapted to conform to the camera plate holder. This enables the operator to develop the image without removing it from the camera holder, effectively blocking actinic light from spoiling the plate and eliminating the requirement for a darkroom.

### BRIEF DESCRIPTION OF THE DRAWINGS

FIG. 1 shows a 1:3 scale perspective view of a preferred embodiment of the mercury vapor apparatus with sliding cover panel in the closed position, and an advantageous embodiment of the same apparatus with the top frame adapted to receive a standard camera plate holder.

FIG. 2 shows a 1:4 scale perspective view of a preferred embodiment of the mercury vapor apparatus with sliding cover panel in the open position.

FIG. 3 shows a 1:2 scale top section view of an embodiment the mercury vapor apparatus.

FIG. 4 shows a 1:2 scale front view of an embodiment of the mercury apparatus with line A-A indicating the section point for FIG. 3.

FIG. 5 shows a 1:2 scale front section view of an embodiment of the mercury apparatus.

FIG. 6 shows a 1:2 scale top view of an embodiment of the mercury apparatus with line B-B indicating the section point for FIG. 5.

FIG. 7 shows a 1:2 scale detail view of the heating system for one embodiment of the mercury apparatus.

### DETAILED DESCRIPTION AND BEST MODE OF IMPLEMENTATION

The present invention provides a unique apparatus for the development of daguerreotype pictures, or other types based on the daguerreotype, with improved convenience for chemical handling and safety, ease of transport for use in remote locations, and the ability to function without the need of a fume hood or darkroom. The system incorporates an alternative to hazardous liquid mercury as the source for mercury vapor necessary to develop daguerreotypes. The present invention is described in enabling detail in the following examples, which may represent more than one embodiment of the present invention.

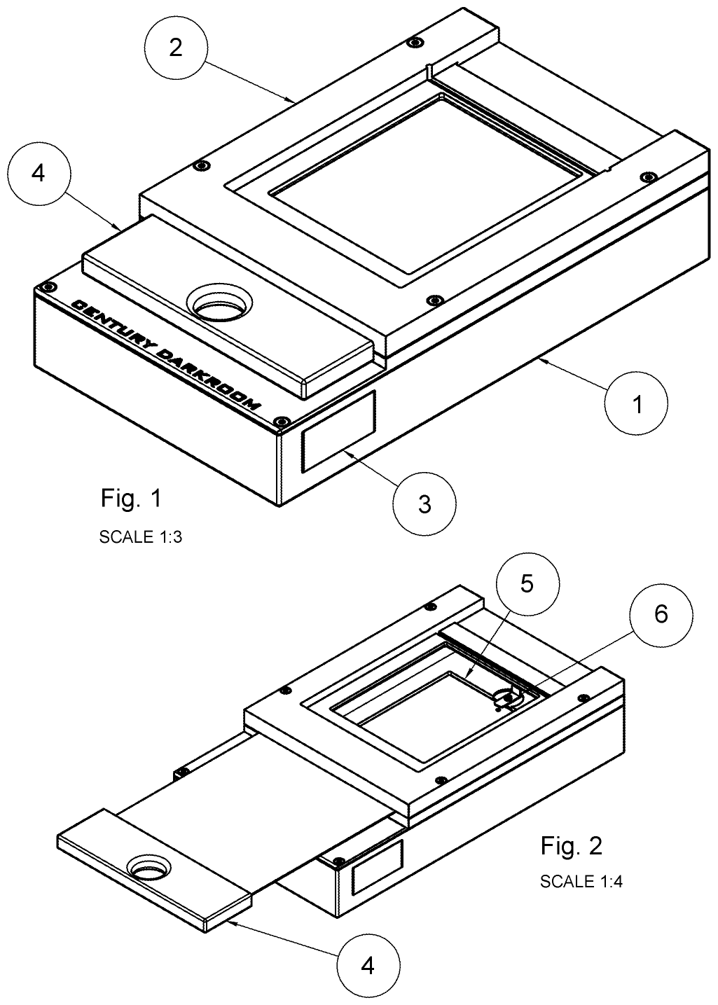

FIG. 1 is a perspective view of the mercury vapor apparatus according to an embodiment of the present invention with a sliding cover panel 4 in the closed position. FIG. 2 is an elevation view of the mercury vapor apparatus of FIG. 1 with the sliding cover panel 4 in the open position. Referring now to FIG. 1, the mercury vapor apparatus includes a main chassis 1, a top frame 2 to receive the daguerreotype plate (or other types) for mercury vapor development, a proportional integral derivative controller (PID) 3 to maintain the correct process temperature, and a sliding cover panel 4.

The main chassis 1 in the present embodiment is milled from a single piece of plastic. In other embodiments the main chassis 1 can be milled from solid wood or steel, or fabricated from joined panels of wood, steel or plastic, or manufactured with 3D additive printing technologies.

The top frame 2 in the present invention is an advantageous embodiment adapted to fit the profile of a standard camera plate holder (not illustrated) familiar to those skilled in the art. This provides a light-tight fit between the camera plate holder and the top frame 2 enabling the user to develop the image under any lighting conditions, eliminating the need for a darkroom. In use, the operator pulls open the sliding cover panel 4, and withdraws the camera plate holder dark slide, which is a component of all camera plate holders and familiar to those skilled in the art. The plate receives the necessary mercury vapor and is developed while remaining in the camera plate holder. In another embodiment, the top frame is designed to fit the profile of any non-standard or custom plate holder for the same purpose. In the present embodiment the top frame 2 is milled from a single piece of plastic. In other embodiments the top frame 2 can be milled from solid wood or steel, or fabricated from joined panels of wood, steel or plastic, or manufactured with 3D additive printing technologies. In another embodiment, the top frame 1 is adapted for inserted frames with apertures of various sizes to receive only the imaging plate having been removed from the camera plate holder. This method of operation, however, requires a means to exclude actinic light or darkroom facilities.

In the present embodiment, the apparatus is adapted for standard 4×5 inch camera plate holders. In other embodiments the apparatus can be scaled to function with any size standard or non standard plate holders.

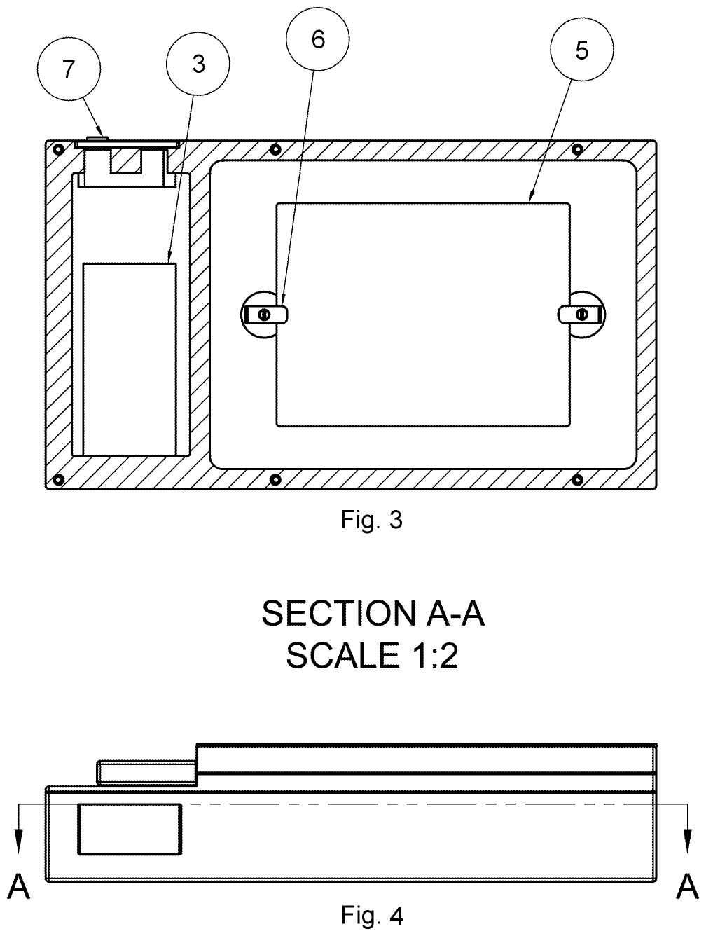

Referring now to FIG. 2, the sliding panel 4 is open to reveal the amalgamated plate 5, and one of two latches 6 placed at each end of the amalgamated plate 5 to secure it in position for transport and use. The latches 6 in the present embodiment are made from stainless steel bent 90 degrees on one end to form a lever and fastened to allow them to pivot around the mounting screw. The use of bent stainless steel latches in this example does not represent a limitation of the present invention as other means to secure the amalgamated plate such as sliding plates, nuts and washers or rails fixed with magnets might be used instead without departing from the spirit and scope of the present invention. The mercury vapor apparatus can be operated in any convenient orientation with the amalgamated plate 5 fastened in position. Referring to FIG. 3, a top section view shows the amalgamated plate 5 and two latches 6 in position. Removal and replacement of the amalgamated plate 5 is done through the top frame 2 opening with the sliding panel 4 drawn out. The latches 6 are rotated to secure or release the plate as necessary.

The amalgamated plate 5 in the present invention is 4.25×5.50 inches and will develop images proportional to the overall dimensions of the apparatus. In other embodiments the amalgamated plate 5 can be increased in size to suit larger plates. The amalgamated plate 5 is prepared in a fume cabinet by spreading a small amount of liquid mercury over the silver, or other base metal, until full amalgamation occurs, which is indicated by complete dryness. If when wiping the surface with a soft cloth it appears shiny and wet and globules of mercury bead up on the surface, amalgamation is not yet complete. Complete amalgamation will require approximately 48 hours as indicated when the entire surface of the plate appears matt greyish-white and does not alter when wiped. The amalgamated silver plate 5 in the present invention contains 99.99% less mercury by weight than the traditional inverted pyramid apparatus described above and provides a significant improvement in safety for the operator. The amalgamated plate 5 contains sufficient mercury to develop several dozen daguerreotype images. When the mercury amalgam is depleted effective development ceases. Before this occurs, the operator is advised to replace it with another freshly amalgamated plate. The amalgam on the spent plate may be renewed for later use. The amalgamated plate is placed directly on top of an aluminum heating plate within the apparatus and retained by latches.

Referring to FIGS. 1, 3 and 7, a PID controller 3 contained within the chassis of the apparatus maintains the desired process temperature by cycling electric current through a silicone resistive electric heating blanket 9 attached to the bottom of the aluminum plate 8, on which is also attached a thermocouple input 10 to monitor the process temperature. In the present embodiment, the system transfers heat to the amalgamated silver plate by physical contact between the aluminum heating plate and the underside of the amalgamated plate. The heating system components of the present embodiment are shown in a detail perspective view in FIG. 7. The present configuration provides a convenient all-in-one system for temperature control. In another embodiment of the invention, the electric PID controller 3 can be built into a separate housing with electric leads that disconnect it from the heating blanket 9 and thermocouple input 10. In another embodiment of the invention which eliminates the PID controller 3, heating blanket 9 and thermocouple input 10, the aluminum heating plate 8 can be heated with an alcohol lamp from below provided a means to monitor the temperature and a suitable support structure is available to hold the apparatus in position above the lamp.

FIG. 3 is a top section view of the main chassis 1 through section line A-A in FIG. 4. Referring to FIG. 3, in the present embodiment, the main chassis includes a chamber for the PID controller 3, and a rocker switch assembly 7. The necessary wiring is not illustrated in FIG. 3. The rocker switch assembly incorporates a 250V 2 A fuse and an IEC 320 C14 mains power inlet receptacle. The PID controller will operate with supply voltage from 100˜240V AC current. In the current embodiment the mercury vapor apparatus can be operated in any country or region, the United States, United Kingdom, or European Union for example, by attaching the appropriate power cord (not illustrated) to rocker switch assembly 7. In another embodiment, the mercury vapor apparatus can be configured to function with 12˜48 V DC current for use with battery power.

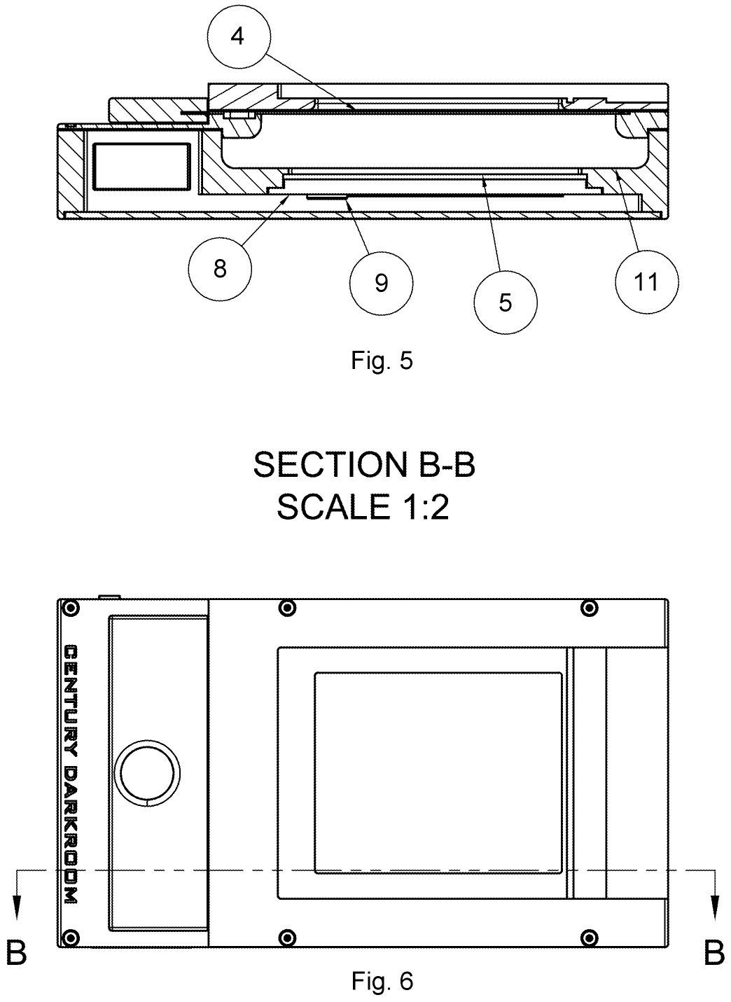

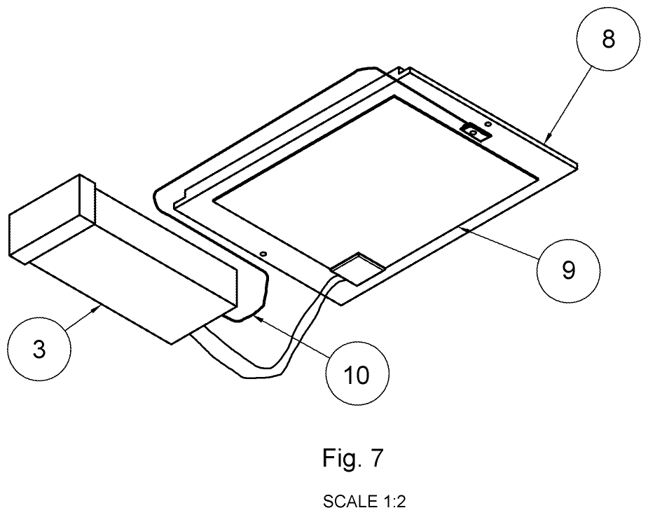

FIG. 5 is a side section view of the main chassis 1 through section line B-B in FIG. 6. Referring to FIG. 5, in the present embodiment, the sliding panel 4 is in the closed position, sealing the vapor chamber 11. The central bottom area of the vapor chamber 11 consists of the amalgamated plate 5, which rests on top of the aluminum heating plate 8 and is retained by two latches (not shown in FIG. 5). Attached to the underside of the aluminum heating plate 8 is a silicone resistive electric heating blanket 9. In the present embodiment, the vapour chamber is of sufficient size to develop plates up to 5×7 inches. In another embodiment the main chassis 1 and related components can be increased in length and width to provide a larger vapor chamber for larger sized plates without the need to alter the size of the amalgamated plate 5, the aluminum heating plate 8 or the silicone resistive electric heating blanket 9. In another embodiment the amalgamated plate 5, the aluminum heating plate 8 and the silicone resistive electric heating blanket 9 may be increased or reduced in size as deemed necessary for various sized imaging plates.

It will be apparent to one with skilled in the art that the mercury vapor system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

What is claimed is:

1. A mercury vapor apparatus for developing daguerreotypes or other types based on the daguerreotype process that contains 99.99% less mercury by weight than the traditional inverted pyramid apparatus used by those skilled in the art.

2. A mercury vapor apparatus that incorporates a metal plate amalgamated with mercury in lieu of liquid mercury in traditional inverted pyramid apparatus used by those skilled in the art, sufficient to develop several dozen images while providing improved convenience for chemical handling and safety.

3. A mercury vapor apparatus for development of daguerreotype plates or other types based on the daguerreotype process, in remote locations due to:
a) ease of transporting and the elimination of risks due to spilled mercury.
b) being adapted for developing daguerreotype plates, and other types based on the daguerreotype process, while in the camera plate holder, eliminating the need for darkroom facilities.
